(19) United States
(12) Patent Application Publication
(10) Pub. No.: US 2024/0055868 A1
(43) Pub. Date: Feb. 15, 2024

(54) ELECTRICAL SYSTEM FOR A RESIDENTIAL SITE

(71) Applicant: LARKFLEET SMART HOMES LIMITED, Bourne (GB)

(72) Inventors: Karl HICK, Bourne (GB); Simon EVANS, Bourne (GB)

(21) Appl. No.: 18/259,115

(22) PCT Filed: Dec. 17, 2021
(86) PCT No.: PCT/GB2021/053363

§ 371 Date: Jun. 23, 2023

(30) Foreign Application Priority Data
Dec. 23, 2020 (GB) 2020529.0

(51) Int. Cl. H02J 3/46; H02J 3/00; H02J 3/32; B60L 55/00

(52) U.S. Cl. CPC H02J 3/46; H02J 3/004; H02J 3/322; H02J 3/0073; B60L 55/00; H02J 2300/28; H02J 2300/24

(57) ABSTRACT

An electrical system and method for supplying electricity to a dwelling on a residential site. An energy management system selectively stores energy in an energy store and selects energy from at least one of a wind power system, a solar power system and a mains electrical source. The energy management system is arranged to: obtain weather data; estimate the amount of electricity the wind power system will generate; estimate the amount of electricity the solar power system will generate; estimate the amount of electrical energy the dwelling will require; determine a strategy for meeting the estimated energy requirements and using electricity; and control operation of an electric vehicle charger to selectively supply electricity from an electric vehicle battery to a consumer unit.

The present invention relates to an electrical system for a residential site, a residential site including the electrical system, a method for providing electricity to at least one dwelling on a residential site, and an energy management system for a dwelling on a residential site.

### BACKGROUND

Due to the impact of climate change, there is a strong desire to make housing more energy efficient and to be powered by low carbon sources of energy. To this end, highly polluting sources of energy such as coal and oil are being replaced by renewal sources of energy. It is also envisaged that the use of natural gas to heat homes will be phased out in the coming years, and natural gas will have to be replaced by an alternative energy source. It is likely that future heating systems will be powered by electricity, which will increase demand on the national grid. At the same time, there will be a significant increase in the number of electrically powered vehicles in use, which will further increase demand on the national grid. Thus when building homes on a new residential site there is a need to ensure that the energy requirements of the homes can be adequately met, the scheme is energy efficient, in particular selecting appropriate heating systems to heat the homes and provide hot water to taps, and that provision is made for charging electric vehicles in a manner that minimizes the risk of overloading the local network. The residential site requires an electricity system that can meet these requirements. The electrical system should also be well balanced to meet energy requirements throughout the year, and make use of available energy storage devices and renewable sources of energy.

The same issues will also affect existing dwellings, accordingly there will be a need to retrofit existing dwellings to be more energy efficient and more sustainable.

Accordingly the invention seeks to provide an electrical system for a residential site, a residential site, a method for providing electricity to a residential site and an energy management system for a residential site that mitigates at least one of the above-mentioned problems, or to at least to provide alternative systems and methods to known systems and methods.

### SUMMARY OF INVENTION

According to one aspect there is provided an electrical system according to claim 1. The invention enables the electrical system to store energy from wind and solar sources in an energy store for later use by the dwelling. This helps to ensure that energy can be stored all year round, and at night, to help meet the energy needs of the dwelling. During the winter, when there is less solar energy but more wind energy, more energy can be stored from the wind power system. During the summer, when there is more solar energy but less wind energy, energy can be stored from the solar power system. Thus the invention can provide a substantial portion of the dwelling's energy needs from low carbon sources. The mains source can be used to meet any shortfall in the dwelling's energy requirements.

According to another aspect, there is provided an electrical system for a residential site having at least one dwelling.

The electrical system can include a consumer unit.

The electrical system can include an energy store.

The electrical system can include a wind power system for converting wind energy into electrical energy. The wind power system can be electrically connected to the energy store.

The electrical system can include a solar power system for converting solar energy into electrical energy. The solar power system can be electrically connected to the energy store.

The electrical system can include a connection electrically connecting the energy store to a mains electrical source.

The electrical system can include an energy management system. The energy management system can be arranged to selectively store energy in the energy store. The energy management system can be arranged to selectively store energy from at least one of the wind power system, the solar power system and the mains electrical source in the energy store during an energy storage procedure. The energy management system can be arranged to selectively supply the consumer unit with electricity from the energy store.

During an energy storage procedure, the energy management system selectively stores, in the energy store, energy from the wind power system, the solar power system and/or the mains source. During an energy storage procedure, the energy management system determines if the electrical input received from the wind power system and/or the solar power system meets a minimum threshold value, and when the minimum threshold value is met, the energy management system stores, in the energy store, energy from the wind power system and/or the solar power system. During some energy storage procedures, the energy management system can select energy from at least two of the wind power system, the solar power system and the mains electrical source to store in the energy store. During some energy storage procedures, the energy management system can select energy from each of the wind power system, the solar power system and the mains electrical source to store in the energy store. Typically, the energy management system selectively stores, in the energy store, energy from the solar power system and/or the wind power system in preference to energy from the mains source. The energy management system can be arranged to store, in the energy store, energy from the mains source to make up any shortfall in energy requirements that cannot be met by the solar power system and/or the wind power system in a given time period.

The electrical system can include at least one inverter device. The at least one inverter device can be arranged to convert a direct current to an alternating current. The at least one inverter device can be arranged to convert a direct current to an alternating current. The electrical system can include a first inverter device. The electrical system can include a second inverter device. The electrical system can include a third inverter device.

The wind power system can be electrically connected to the energy store via the at least one inverter device. The wind power system can be electrically connected to the energy store via the second inverter device and the first inverter device. The second inverter device can convert a direct current generated by the wind power system to an alternating current. The first inverter device can convert the alternating current received from the second inverter device to a direct current. The first inverter device can supply the direct current to the energy store.

The solar power system can be electrically connected to the energy store via the at least one inverter device. The solar power system can be electrically connected to the energy store via the third inverter device and the first inverter device. The third inverter device can convert a direct current generated by the solar power system to an alternating current. The first inverter device can convert the alternating current received from the third inverter device to a direct current. The first inverter device can supply the direct current to the energy store.

The solar power system can be electrically connected to the energy store directly. That is, solar power system can supply a direct current to the energy store without passing through an inverter device. The solar power system can be electrically connected to the energy store via the first inverter device. The solar power system can supply a direct current to the first inverter device. The first inverter device can supply the direct current to the energy store.

The mains electricity source can be electrically connected to the energy store via the at least one inverter device. The mains electricity source can be electrically connected to the energy store via the first inverter device. The mains electricity source can supply an alternating current to the first inverter device. The first inverter device can convert the alternating current received from the mains source to a direct current. The first inverter can supply the direct current to the energy store.

The first inverter device can receive a direct current from the energy store. The first inverter device can be arranged to convert the direct current to an alternating current. The first inverter device can be electrically connected to the consumer unit. The first inverter can be arranged to supply the alternating current to the consumer unit. The first inverter can be arranged to supply the alternating current to at least one of the, local electrical network and the mains grid.

The at least one inverter device can include a hybrid inverter device.

The wind power system can be electrically connected to the consumer unit. The energy management system can be arranged to selectively provide electricity to the consumer unit from the wind power system. Thus, electricity can be supplied to the consumer unit from the wind power system without having first been stored in the energy store. The wind power system can be electrically connected to the consumer unit via the second inverter device. The second inverter device converts a direct current output from the wind power system to an alternating current for input to the consumer unit.

The solar power system can be electrically connected to the consumer unit. The energy management system can be arranged to selectively provide electricity to the consumer unit from the solar power system. Thus, electricity can be supplied to the consumer unit from the solar power system without having first been stored in the energy store. The solar power system can be electrically connected to the consumer unit via the first and/or third inverter devices. The first inverter device can convert a direct current output from the solar power system to an alternating current for input to the consumer unit. The third inverter device can convert a direct current output from the solar power system to an alternating current for input to the consumer unit.

The electrical system can include a connection electrically connecting the mains electrical source to the consumer unit. The energy management system can be arranged to selectively provide electricity to the consumer unit from the mains source. Thus, electricity can be supplied to the consumer unit from the mains source without having first been stored in the energy store.

The energy management system can be arranged to selectively export electricity from the energy store. Electricity exported from the energy store can be exported to a local electricity network for distribution to other dwellings located on the residential site. Electricity exported from the energy store can be exported to the mains source for distribution on the national grid. The energy management system can be arranged to export electricity when estimated energy requirements for the dwelling are low. The energy management system can be arranged to export electricity when it is economical to do so. When exporting energy from the energy store, a direct current can be supplied from the energy store to the first inverter. The first inverter can convert the direct current to an alternating current. The alternating current can be exported to at least one of the local electrical network and the national grid.

The energy store can comprise at least one rechargeable electrochemical cell (communally referred to as a rechargeable battery). It will be appreciated that other types of energy store can be used to store energy and to release the stored energy as electricity. The energy store is typically located at the dwelling.

The at least one rechargeable electrochemical cell can comprise a battery that includes lithium.

The wind power system is dedicated to the residential site. The wind power system can include at least one wind turbine. The wind power system can include a plurality of wind turbines. The wind turbines can be located off the residential site. The wind turbines can be electrically connected to the local electrical network on the residential site by means of a public or private connection. Thus the wind power system can be electrically connected to the energy store via the public or private connection and the local electrical network. The wind power system can be electrically connected to the consumer unit via the public or private connection and the local electrical network. The wind turbines are electrically connected to the second inverter. Typically, the second inverter device is located adjacent the wind turbines. The second inverter converts a direct current form the wind turbines to an alternating current prior to supplying the public or private connection, and hence prior to the site electrical meter.

At least one wind turbine can include a frame having first and second longitudinal members arranged parallel to one another. At least one turbine blade can be located between the first and second longitudinal members. The at least one turbine blade can be rotatably supported at a first end by the first longitudinal member. The at least one turbine blade can be rotatably supported at a second end by the second longitudinal member. At least one turbine blade can be arranged to rotate about an axis that is perpendicular to the first and second longitudinal members. The wind turbine can include a plurality of turbine blades, and typically includes 4 to 8 blades. Each turbine blade can be located between the first and second longitudinal members. Each turbine blade can be rotatably supported at a respective first end by the first longitudinal member and rotatably supported at a respective second end by the second longitudinal member. Each turbine blade can be arranged to rotate about a respective axis that is perpendicular to the first and second longitudinal members.

The at least one turbine blade can have an electrical generator. A first part of the electrical generator can be attached to the at least one turbine blade. A second part of the electrical generator can be mounted on one of the first and second longitudinal members. Rotational movement of the first part of the generator with respect to the second part of the generator generates an electrical current. Each turbine blade can have a respective electrical generator.

The solar power system can include at least one, and preferably a plurality of photovoltaic modules. The dwelling can include at least one photovoltaic module. The dwelling at least one photovoltaic module is dedicated to providing electricity to the dwelling, save any excess electricity that is exported. The at least one dwelling photovoltaic module is electrically connected to the energy store. The at least one dwelling photovoltaic module is electrically connected to the consumer unit via the solar power system first inverter device. For residential sites having a plurality of dwellings, at least some of the dwellings, and preferably each dwelling, can include at least one photovoltaic module. The first inverter device can convert a direct current received from the at least one dwelling photovoltaic module to an alternating current. The first inverter device can supply the alternating current to the consumer unit and/or export the alternating current.

The solar power system can include at least one photovoltaic module, and preferably a plurality of photovoltaic modules, located at a solar farm. The solar farm can be located off the residential site, or on the residential site. The solar farm photovoltaic modules are dedicated to the residential site and can be electrically connected to the local electrical network on the residential site by means of a public or private connection. The solar power system can be electrically connected to the energy store via the public or private connection and the local electrical network. The solar power system can be electrically connected to the consumer unit via the public or private connection and the local electrical network. The third inverter device can be located at the solar farm. The third inverter device can be electrically connected to the photovoltaic modules. The third inverter device can convert a direct current generated by the photovoltaic modules to an alternating current prior to supplying the public or private connection, and hence prior to the site electrical meter. Typically, the third inverter device is located adjacent the photovoltaic modules.

The energy management system can comprise at least one programmable logic controller.

The energy management system can be arranged to determine the amount of energy stored in the energy store. For example, the energy management system can be arranged to determine the amount of electrical charge stored in the at least one electrochemical cell.

The energy management system can be arranged to initiate an energy storage procedure when the determined amount of energy stored in the energy store is less than a threshold value. The energy management system can be arranged to determine the energy requirements to fill the energy store to its maximum capacity. For example, the energy management system can be arranged to determine the amount of electrical energy required to charge the at least one electrochemical cell to its maximum charge.

The energy management system can be arranged to obtain historical data relating to electrical usage for the dwelling.

The energy management system can be arranged to obtain weather data. The weather data can be stored in a database, for example a Meteorological Office database. The weather data can be obtained from instruments located adjacent the wind turbines and the photovoltaic modules. The weather data can include data relating to wind speed at the location of the wind turbines. The weather data can include data relating to available sunlight at the location of the photovoltaic modules. The weather data can include data relating to air temperature.

The energy management system can be arranged to estimate the amount of electricity the wind power system will generate over a relevant period. The estimate can be calculated at least in part on the basis the obtained weather data.

The energy management system can be arranged to estimate the amount of electricity the solar power system will generate over a relevant period. The estimate can be calculated at least in part on the basis the obtained weather data.

The energy management system can be arranged to estimate the amount of electricity the wind power system will generate over a relevant period. The estimate can be calculated at least in part on the basis the obtained weather data.

The energy management system can be arranged to obtain data relating to user preferences. The user preferences can include indications of user's likely energy use within the relevant period. For example, electric vehicle is required tomorrow for a 50 mile drive.

The energy management system can be arranged to estimate the amount of electrical energy the dwelling will require for a relevant period of time. The energy management system can be arranged to estimate the amount of electrical energy the dwelling will require for each hour or half hour of the relevant period of time. The estimate can be determined at least in part on the basis of at least one of the historical data and the user preference data. The estimate can be determined at least in part on the basis of stored predetermined scenarios.

The stored predetermined scenarios can be stored in a memory device. The relevant period of time is a predetermined period of time, for example, the period of time can be 1 hr, 5 hrs, 10 hrs, 12 hrs, 20 hrs, 24 hrs, 36 hrs, or 48 hrs. Any suitable period of time can be used.

The energy management system can be arranged to determine a strategy for meeting the estimated energy requirements for the dwelling based at least in part on the estimated availability of electricity from the wind power system and the solar power system. The energy management system can be arranged to use electricity from the mains source to make up any shortfall in energy supplied by the wind power system and the solar power system. The energy management system can be arranged to preferentially store energy obtained from the wind power system and/or the solar power system in the energy store, over energy obtained from the mains source. At night-time, the energy management system can be arranged to preferentially store energy received from the wind power system in the energy store. At times of high wind speed, the energy management system can be preferentially arranged to store energy received from the wind power system in the energy store. At times of high solar energy, the energy management system can be arranged to preferentially store energy received from the solar power system in the energy store. The energy management system can be arranged to store energy received from the mains source in the energy store if the energy management system determines that there is insufficient energy available from the wind power system and the solar power system to meet a target energy. The energy management system can be arranged to store energy received from the mains source in the energy store if the energy management system determines that a cheap mains source tariff applies, for example an off-peak tariff, which typically applies overnight.

Periodically, the energy management system can be arranged to determine a new estimate for the amount of energy the dwelling requires for a new period of time. In some embodiments, the energy management system can be arranged to determine an estimate of the amount of energy the dwelling requires in a calculation window. In some embodiments, there can be a plurality of calculation windows during a 24 hour period. In some embodiments there are two calculation windows during a 24 hour period. In some embodiments there are three calculation windows during a 24 hour period. In some embodiments there are four calculation windows during a 24 hour period. In some embodiments, a calculation window takes place in the morning. In some embodiments, a calculation window takes place during the afternoon. In some embodiments a calculation window takes place during the evening. In some embodiments a calculation window takes place during night-time.

The energy management system can be arranged to store, in the energy store, energy received from one of the wind power system, the solar power system and the mains source, and to simultaneously power the consumer unit with electricity received from another one of the wind power system, the solar power system and the mains source.

The electrical system can include an electric vehicle charger. The electric vehicle charger can be electrically connected to the consumer unit and can be powered by electricity received from the consumer unit. The electric vehicle charger can be a two-way type electric vehicle charger, which enables electricity to be supplied from the electric vehicle battery to the consumer unit.

The energy management system can be arranged to store energy obtained from the wind power system and/or the solar power system in an electric vehicle battery. The energy management system can be arranged to make up any shortfall of energy from the mains electrical source. At night-time, the energy management system can be arranged to preferentially store energy received from the wind power system in the electric vehicle battery. At times of high wind speed, the energy management system can be preferentially arranged to store energy received from the wind power system in the electric vehicle battery. At times of high solar energy the energy management system can be arranged to preferentially store energy received from the solar power system in the electric vehicle battery.

The energy management system can control operation of the electric vehicle charger to selectively supply electricity from the electric vehicle battery to the consumer unit. The electrical system can include a circuit breaker to selectively supply electricity from the electric vehicle battery to the consumer unit. The circuit breaker can be controlled by a micro-controller. The energy management system, or a third party such as a Distribution Network Operator (DNO), can control operation of the micro-control selective supply electricity from the electric vehicle battery to the consumer unit in response to local network conditions.

The electrical system can include a heating system arranged to heat the dwelling. The heating system can include a heat pump. The heat pump can be electrically connected to the consumer unit. The heat pump can be powered by electricity received from the consumer unit. The heat pump can be arranged to heat a fluid, such as water. The fluid can be circulated through underfloor pipes and/or wall mounted radiators. The heat pump can comprise an air source heat pump or a ground source heat pump. The heating system can include an infra-red heating device. The infra-red heating device can be electrically connected to the consumer unit. The infra-red heating device can be powered by electricity received from the consumer unit.

The electrical system can include a continuous liquid flow heating device arranged to provide hot water to the dwelling. The continuous liquid flow heating device can be electrically connected to the consumer unit and is powered by electricity received from the consumer unit. The continuous liquid flow heating device can be connected to a mains water supply and at least one tap. Typically, the continuous liquid flow heating device is arranged to heat water to a temperature in the range 30° C. to 100° C. Having a continuous liquid flow heating device in the electrical system relieves the heat pump from having to provide both hot water for heating the dwelling and to the taps, both of which have different heating requirements. Thus the heat pump is able to function more efficiently by only having to provide hot water for heating purposes. The continuous liquid flow heating device can include a pipe having an electric heating element located within the pipe. The heating element can take up at least 80% of the volume within the pipe, and preferably at least 85% of the volume within the pipe thereby leaving a relatively small volume available to the water. This maximises contact between the water and the heating element, and leads to rapid heating of the water. The pipe can have a coiled arrangement.

The heating system can include a thermal energy store. The thermal energy store can comprise at least one of a tank for storing hot water; a smart tank for storing hot water; and a thermal energy store having a phase change material (PCM). In some embodiments, the thermal energy store can be provided instead of a continuous liquid flow heating device. In some embodiments, the energy management system can be arranged to communicate with the thermal energy store to determine the level of energy stored therein. For example, the energy management system can be arranged to determine the temperature of water stored in the tank or smart tank. The energy management system can be arranged to determine the temperature of the PCM stored in the thermal energy store.

The electrical system can include at least one of the following electrically connected to the consumer unit, and arranged to be powered by electricity received from the consumer unit: at least one ring circuit, including several mains sockets; at least one lighting circuit; appliances; a security system; assisted living systems; and a water flow monitoring device.

The energy store can be dedicated to a single dwelling.

For residential sites having a plurality of dwellings, at least some dwellings, and preferably each dwelling, can have a respective consumer unit, a respective energy store, and a respective energy management system. Each dwelling can have at least one of: a respective heating system, a respective continuous liquid flow heating device and a respective electric vehicle charger.

For residential sites having a plurality of dwellings, each dwelling having a respective consumer unit, the energy store can comprise a communal energy store. The communal energy store can comprise a battery, for example a battery that includes lithium battery. The communal battery can have a relatively large capacity, for example, the communal battery can have a capacity greater than or equal to 1 Mega Watt. The communal energy store is electrically connected to each dwelling consumer unit. The communal energy store provides electricity to each of the consumer units electrically connected thereto. The energy management system in each dwelling can be arranged to selectively supply electricity to its respective consumer unit from the communal energy store. Thus the communal energy store helps provide for the day to day electrical needs of the dwellings in a similar manner to the individual dwelling energy stores.

The energy management system can comprise a communal energy management system arranged to selectively provide electricity from the communal energy store to each consumer unit electrically connected to the communal energy store. The communal energy management system can be arranged to selectively export electricity from the communal energy store. Electricity exported from the communal energy store can be exported to a local electricity network for distribution to other dwellings located on the residential site, which are not otherwise supplied by the communal energy store. Electricity exported from the energy store can be exported to the mains source for distribution on the national grid.

The electrical system can include a plurality of communal energy stores, which each communal energy store being electrically connected a set of the consumer units (and hence a set of dwellings). Each communal energy store can have a respective communal energy management system, which is arranged to selectively supply each consumer unit in the set of consumer units with electricity.

In some embodiments, the residential site can have some dwellings that each have an individual energy store and respective individual energy management system, and some dwellings that share a communal energy store and communal energy management system.

The electrical system can include a backup energy store, such as a backup battery. The backup energy store can be arranged to provide electricity to the local network in the event that electricity is not supplied to the site from the mains source. The backup energy store can be arranged to provide electricity to the local electrical network for planned mains source outages. The backup energy store can be arranged to provide electricity to the local electrical network for unplanned mains source outages, for example unexpected loss of power due to power line failure. The backup energy store can be arranged to provide grid services to the local electrical network. The backup energy store can be arranged to balance the local electrical network. The backup energy store can be arranged to balance the frequency of electricity supplied to the local electrical network.

According to another aspect, there is provided a residential site, including: at least one dwelling; and an electrical system according to any configuration described herein. The residential site can include a plurality of dwellings arranged according to any configuration described herein.

According to another aspect, there is provided a method according to claim 29. The invention enables the electrical system to store energy from wind and solar sources in an energy store for later use by the dwelling. This helps to ensure that energy can be stored all year round, and at night, to help meet the energy needs of the dwelling. During the winter, when there is less solar energy but more wind energy, more energy can be stored from the wind power system. During the summer, when there is more solar energy but less wind energy, energy can be stored from the solar power system. Thus the invention can provide a substantial portion of the dwelling's energy needs from low carbon sources. The mains source can be used to meet any shortfall in the dwelling's energy requirements.

According to another aspect, there is provided a method for providing electricity to at least one dwelling on a residential site.

The method can include providing an electrical system having a consumer unit, an energy store, a wind power system for converting wind energy into electrical energy, a solar power system for converting solar energy into electrical energy, a connection electrically connecting the energy store to a mains electrical source, and an energy management system.

Each of the wind power system and the solar power system are electrically connected to the energy store.

The method can include the energy management system selectively storing energy in the energy store.

The method can include the energy management system selectively storing energy from at least one of the wind power system, the solar power system and the mains electrical source in the energy store during an energy storage procedure.

The method can include the energy management system selectively supplying the consumer unit with electricity from the energy store.

The method can include the energy management system exporting electricity from the energy store to at least one of a local electricity network for distribution to other dwellings located on the residential site and to the mains source for distribution on the national grid.

The method can include the energy management system determining the amount of energy stored in the energy store.

The method can include the energy management system storing energy in the energy store when the determined amount of energy stored in the energy store can be less than a threshold value.

The method can include the energy management system obtaining historical data relating to electrical usage for the dwelling.

The method can include the energy management system obtaining weather data.

The method can include the energy management system estimating the amount of electricity the wind power system will generate over a relevant period. The estimation can be based at least in part on the weather data.

The method can include the energy management system estimating the amount of electricity the solar power system will generate over a relevant period. The estimation can be based at least in part on the weather data.

The method can include the energy management system obtaining data relating to user preferences.

The method can include the energy management system estimating the amount of energy the dwelling can be likely to require per hour or half hour for the period of time.

The method can include the energy management system determining and executing a strategy for meeting the estimated energy requirements for the dwelling based at least in part on the estimated availability of electricity from the wind power system and the solar power system. The method can include the energy management system using electricity from the mains source to make up any shortfall in energy supplied by the wind power system and the solar power system.

The method can include the energy management system storing, in the energy store, energy received from one of the wind power system, the solar power system and the mains source, and to simultaneously power the consumer unit with electricity received from another one of the wind power system, the solar power system and the mains source.

The method can include providing an electric vehicle charger. The electric vehicle charger can be electrically connected to the consumer unit and can be powered by electricity received from the consumer unit. The energy management system can be arranged to store energy obtained from the wind power system and/or the solar power system in an electric vehicle battery. The method can include making up any shortfall of energy from the mains electrical source.

The method can include the energy management system control selectively supplying electricity from the electric vehicle battery to the consumer unit.

According to another aspect, there is provided an energy management system according to claim 36. The invention enables the electrical system to store energy from wind and solar sources in an energy store for later use by the dwelling. This helps to ensure that energy can be stored all year round, and at night, to help meet the energy needs of the dwelling. During the winter, when there is less solar energy but more wind energy, more energy can be stored from the wind power system. During the summer, when there is more solar energy but less wind energy, energy can be stored from the solar power system. Thus the invention can provide a substantial portion of the dwelling's energy needs from low carbon sources. The mains source can be used to meet any shortfall in the dwelling's energy requirements.

According to another aspect, there is provided an energy management system for use in a residential site electrical system. The electrical system can have a consumer unit, an energy store a wind power system for converting wind energy into electrical energy, the wind power system is electrically connected to the energy store, a solar power system for converting solar energy into electrical energy, the solar power system is electrically connected to the energy store, and a connection electrically connecting the energy store to a mains electrical source.

The energy management system can be arranged to selectively store energy in the energy store.

The energy management system can be arranged to selectively store energy from at least one of the wind power system, the solar power system and the mains electrical source in the energy store during an energy storage procedure.

The energy management system can be arranged to selectively supply the consumer unit with electricity from the energy store.

The system can comprise at least one programmable logic controller. The at least one programmable logic controller can be programmed to carry out all of the functions of the energy management system.

The energy management system can be arranged to export electricity from the energy store to at least one of a local electricity network for distribution to other dwellings located on the residential site and to the mains source for distribution on the national grid.

The energy management system can be arranged to determine the amount of energy stored in the energy store.

The energy management system can be arranged to store energy in the energy store when the determined amount of energy stored in the energy store can be less than a threshold value.

The energy management system can be arranged to obtain historical data relating to electrical usage for the dwelling.

The energy management system can be arranged to obtain weather data.

The energy management system can be arranged to estimate the amount of electricity the wind power system will generate over the relevant period. The estimate can be calculated at least in part on the basis the obtained weather data.

The energy management system can be arranged to estimate the amount of electricity the solar power system will generate over the relevant period. The estimate can be calculated at least in part on the basis the obtained weather data.

The energy management system can be arranged to obtain data relating to user preferences.

The energy management system can be arranged to estimate the amount of energy the dwelling is likely to require per hour or half hour for the period of time.

The energy management system can be arranged to determine and execute a strategy for meeting the estimated energy requirements for the dwelling based at least in part on the estimated availability of electricity from the wind power system and the solar power system.

The energy management system can be arranged to us electricity from the mains source to make up any shortfall in energy supplied by the wind power system and the solar power system.

The energy management system can be arranged to store, in the energy store, energy received from one of the wind power system, the solar power system and the mains source, and to simultaneously power the consumer unit with electricity received from another one of the wind power system, the solar power system and the mains source.

The electrical system can include an electric vehicle charger. The electric vehicle charger can be electrically connected to the consumer unit and can be powered by electricity received from the consumer unit. The energy management system can be arranged to store energy obtained from the wind power system and/or the solar power system in an electric vehicle battery. The energy management system can be arranged to make up any shortfall of energy from the mains electrical source.

The energy management system can control operation of the electric vehicle charger to selectively supply electricity from the electric vehicle battery to the consumer unit.

According to another aspect, there is provided an electrical system for a residential site having at least one dwelling, the electrical system including: a consumer unit; an energy store; a wind power system for converting wind energy into electrical energy, the wind power system is electrically connected to the energy store; a solar power system for converting solar energy into electrical energy, the solar power system is electrically connected to the energy store; and an energy management system, wherein the energy management system is arranged to selectively store energy from at least one of the wind power system and the solar power system to store in the energy store during an energy storage procedure, and wherein the energy management system is arranged to selectively supply the consumer unit with electricity from the energy store.

According to another aspect, there is provided a method for providing electricity to at least one dwelling on a residential site, the method including: providing an electrical system having a consumer unit, an energy store, a wind power system for converting wind energy into electrical energy, the wind power system is electrically connected to the energy store, a solar power system for converting solar energy into electrical energy, the solar power system is electrically connected to the energy store, and an energy management system; the energy management selectively storing energy from at least one of the wind power system and the solar power system in the energy store during an energy storage procedure; and the energy management system selectively supplying the consumer unit with electricity from the energy store.

According to another aspect, therein is provided an energy management system for use in a residential site electrical system having a consumer unit, an energy store a wind power system for converting wind energy into electrical energy, the wind power system is electrically connected to the energy store, and a solar power system for converting solar energy into electrical energy, the solar power system is electrically connected to the energy store; wherein the energy management system is arranged to selectively store energy from at least one of the wind power system and the solar power system in the energy store during an energy storage procedure, and wherein the energy management system is arranged to selectively supply the consumer unit with electricity from the energy store.

### BRIEF DESCRIPTION OF DRAWINGS

Embodiments will now be described, by way of example only and with reference to accompanying drawings, in which:

FIG. 1 is a high-level schematic of an electrical system for a residential site according to a first embodiment;

FIG. 2 is a schematic of the electrical system of FIG. 1 focusing on a dwelling in the residential site;

FIG. 3 is a simplified schematic of the dwelling of FIG. 2, showing energy flows;

FIG. 4 is a schematic of the dwelling of FIG. 2, showing electronic communications; and

FIG. 5 is flow diagram of an algorithm used by an energy management system to control the flow of energy to and from an energy storage device.

### DETAILED DESCRIPTION

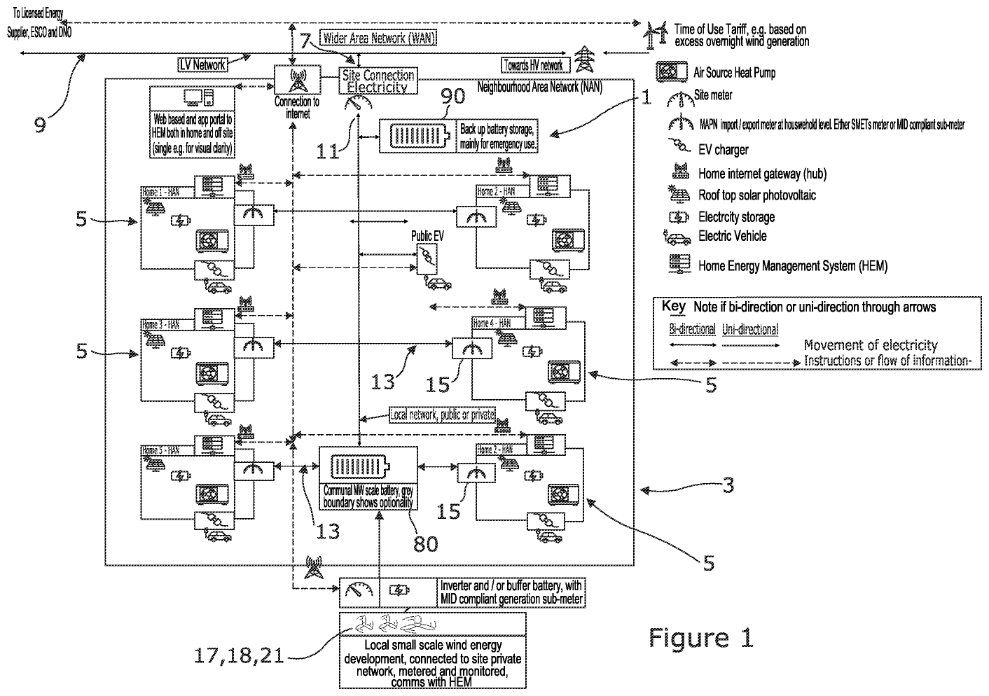

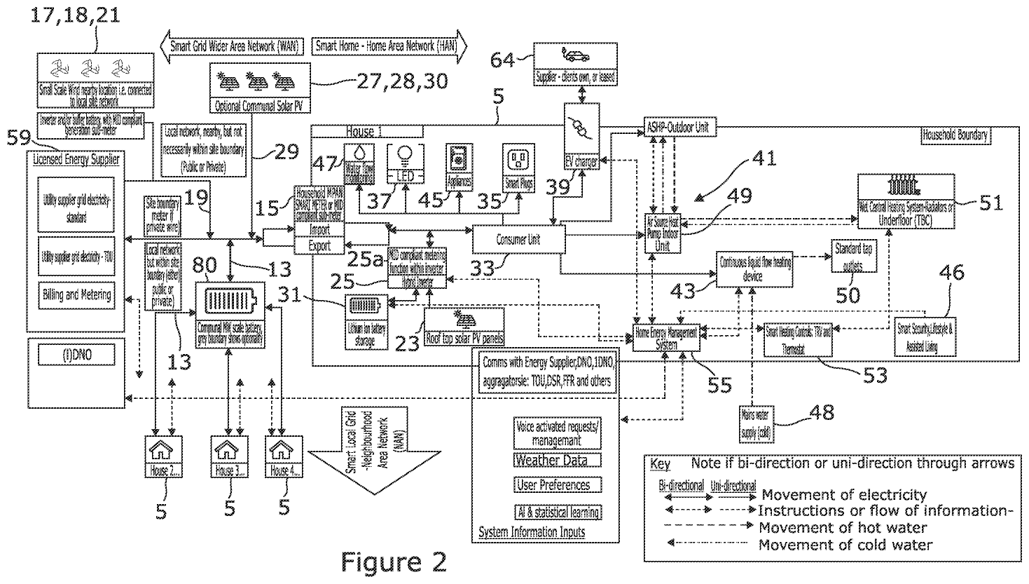

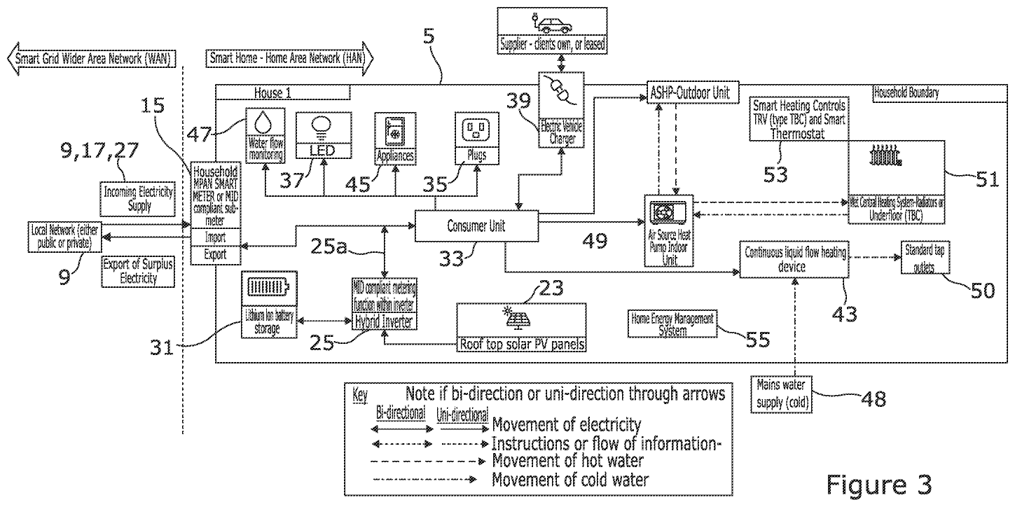

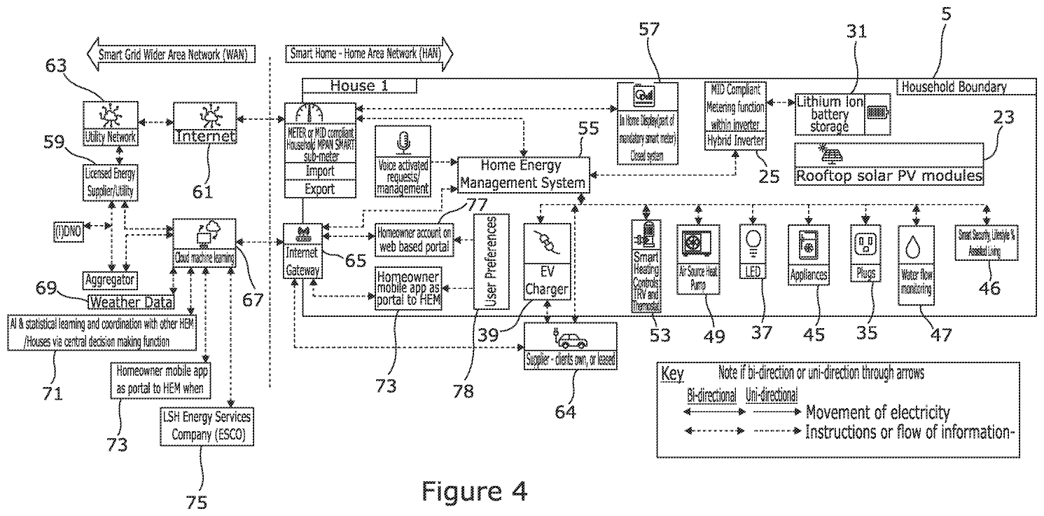

FIG. 1 shows an electrical system 1 for a residential site 3 in accordance with the invention. The site 3 shown in FIG. 1 includes six dwellings 5 for illustrative purposes, however the site can include any practicable number of dwellings. For example, the site 3 can include a single dwelling, tens of dwellings, hundreds of dwellings or thousands of dwellings. Typically, the site 3 will include around 1 to 200 dwellings, however the site 3 can include any practicable number of dwellings 5, and therefore may have more than 200 dwellings 5.

The site 3 includes a connection 7 to the mains electricity grid 9. A site electricity meter 11 is provided, which monitors electricity imported into the site 3 from the mains supply 9 and electricity exported from the site to the mains grid 9. Each dwelling 5 is connected to mains supply 9 via a local network 13. Each dwelling has an electricity meter 15 to monitor usage of mains electricity by the respective dwelling 5. The electricity meter 15 is arranged to communicate wirelessly with a visual display unit 57, for example by Wi-Fi, to provide residents with metering information. The electricity meter 15 is arranged to communicate with the licensed energy supplier 59 via the internet 61 and a utility network 63.

The site 3 is also electrically connected to a wind power system located at wind farm. The wind power system includes apparatus 17 arranged to generate electricity from the wind. The apparatus 17 is electrically connected to the site 3 via a connection 19 such as a public or private line. The apparatus 17 can comprise any suitable wind turbines 17 required to meet the requirements of the site 3. In some embodiments, the apparatus comprises wind turbines 17 supplied by Spinetic Energy Limited of Wiltshire, United Kingdom, for example as described in any of WO2019030499, GB2565294, GB2560971, GB2546635, GB2545278, GB2525134 and GB2476126, the contents of which are hereby incorporated by reference. Wind turbines 17 of this type are sometimes referred to as “wind fences” and comprise a frame having upper and lower horizontal support members and several vertically arranged turbine blades (typically five or six blades) located between the upper and lower horizontal support members. Each blade is rotatably attached to each of the upper and lower support members. Each blade is arranged to rotate about its own vertical axis. Each blade has an electrical generator associated therewith. A first part the generator can be attached to the blade. A second part can be mounted on one of the horizontal supports. As the blade rotates, the generator generates electricity. The advantage of these wind turbines 17 is that they are relatively small, are designed to extract energy from moderate wind speeds and can self-start at wind speeds of around 2 m/s from any direction relative to a turbine blade. A wind turbine 17 comprising a fence of six blades can generate around 994 kWh at a wind speed of 4.5 m/s. A typical dwelling 5, may require two to five wind turbines 17 to provide a reasonable amount of energy throughout the year. For example, a typical three-bedroom house 5 may require three wind turbines 17. The system is modular so it can be scaled to meet the site 3 requirements. These characteristics help to ensure that a suitable location can be found for the wind farm within an acceptable distance from the site 3. The wind turbines 17 generate a direct current (DC) output. A second inverter 18 is electrically connected to the wind turbines 17. The second inverter 18 converts the DC output from the wind turbines 17 to an alternating current (AC) for onward transmission to the local electrical network 13. Optionally, the wind turbines 17 can be electrically connected to a local battery. The DC output from the wind turbines 17 is supplied to the local battery. The local battery is electrically connected to the second inverter 18. A DC output is supplied from the local battery to the second inverter 18, which converts it to an AC for onward transmission to the local electrical network 13.

The wind turbines 17 at the wind farm is dedicated to supplying electricity to the site 3, and can be located on the site 3 or alternatively can be located off the site 3, say within three kilometres of site 3. Having the wind farm located off site provides greater flexibility to select an appropriate location, for example a location that has greater average wind speeds than the site 3.

A generation meter 21 is provided to monitor the electricity flowing to the site 3 from the wind farm.

Optionally, the electrical system 1 can include a dedicated solar power system located at a solar farm. The solar power system can include photovoltaic modules 27 arranged to generate electricity from solar energy. The solar farm is connected to the site 3 via a connection 29 such as a public or private line. The photovoltaic modules 27 can comprise any suitable photovoltaic modules that meet the requirements of the site 3. The solar farm is relatively small scale. The solar farm is dedicated to supplying electricity to the site 3, and can be located on the site 3 or alternatively can be located off the site 3, say within three kilometres of site 3. Having the solar farm located off site provides greater flexibility to select an appropriate location, for example a location that has greater average amount of sunlight than the site 3. A generation meter can be provided to monitor the electricity flowing to the site 3 from the solar farm. The photovoltaic modules 27 generate a DC output. A third inverter 30 is electrically connected to the photovoltaic modules 27. The DC output is converted to an AC by the third inverter 30 for transmission to the local electrical network 13.

The electrical arrangement of one of the dwellings 5 will now be described. However the arrangement is also applicable to at least some of the other dwellings 5 on the site 3, and typically each of the dwellings 5 on the site 3.

The electrical system 1 includes a solar power system having at least one photovoltaic module 23 arranged to generate electricity from solar energy. The at least one photovoltaic module 23 arranged to generate electricity for the dwelling 5. Typically, the dwelling 5 includes serval photovoltaic modules 23. Each photovoltaic module 23 arranged to generate electricity for the dwelling 5. Each photovoltaic module 23 is arranged on the dwelling 5 in a manner that maximises the amount of electricity generated, for example each module 23 can be south facing where possible. Each photovoltaic module 23 generates a DC output. The DC can be supplied to the battery 31 directly, or via the first inverter 25. In another mode of operation, the first inverter 25 is arranged to convert the DC output from the photovoltaic modules 23 to an AC, which can then be supplied to at least one of: the consumer unit 33, to the local electrical network 13 for distribution to other dwellings 5, and to the mains source 9 for wider distribution.

The electrical system 1 includes an electricity meter 25a, which monitors the output of its photovoltaic modules 23. The electricity meter 25a can be part of the inverter 25 or can be separate from the inverter 25. The electricity meter 25a is arranged to send data to communicate with the licensed energy supplier 59 and the energy management system 55 via the internet 61 and a utility network 63, and other communications protocols.

The first inverter 25 can comprise a hybrid inverter in some embodiments.

The dwelling 5 includes an energy store such as a rechargeable battery 31. The rechargeable battery 31 can be a lithium based battery, that is, a battery that includes lithium. However any suitable type of rechargeable battery can be used. The photovoltaic modules 23 are electrically connected to the rechargeable battery 31. Electricity can be selectively supplied from the photovoltaic modules 23 to the rechargeable battery 31, thereby recharging the battery 31.

The rechargeable battery 31 is electrically connected to the mains supply 9. The rechargeable battery 31 is electrically connected to the mains supply 9 via the first inverter 25. Electricity can be selectively supplied from the mains supply 9 to the rechargeable battery 31 via the first inverter 25, thereby recharging the battery 31. The first inverter 25 converts an AC received from the mains source to a DC. The first inverter 25 supplies the DC to the battery 31.

The rechargeable battery 31 is electrically connected to the wind turbines 17. The rechargeable battery 31 is electrically connected to the wind turbines 17 via the second inverter 18, the connection 19, local electrical network 13, and the first inverter 25. Electricity can be selectively supplied from the wind turbines 17 to the rechargeable battery 31 via the first inverter 25, thereby recharging the battery 31. The first inverter 25 is arranged to convert the AC received from the second inverter 18 to a DC. The first inverter 25 supplies the DC to the battery 31, to store energy in the battery 31.

For embodiments having a solar farm, the rechargeable battery 31 is electrically connected to the photovoltaic modules 27. The rechargeable battery 31 is electrically connected to the photovoltaic modules 27 via the third inverter 30, the connection 29, the local electrical network 13 and the first inverter 25. Electricity can be supplied from the photovoltaic modules 27 to the rechargeable battery 31 via the third and first inverters 30,25, thereby recharging the battery 31. The third inverter 30 converts a DC from the photovoltaic modules 27 to AC, which is supplied to the first inverter 25. In one mode of operation, the first inverter 25 converts the AC into a DC. The first inverter 25 supplies the battery 31 with the DC to store energy in the battery 31.

The dwelling 5 includes a consumer unit 33. The rechargeable battery 31 is electrically connected to the consumer unit 33 via the first inverter 25. In one mode of operation, the first inverter 25 is arranged to convert a DC from the rechargeable battery 31 to an AC to power the consumer unit 33.

The consumer unit 33 can be electrically connected directly to the mains supply 9. This enables an AC to be provided directly to the consumer unit 33 from the mains supply 9 without having to go via the battery 31.

The wind turbines 17 are electrically connected the consumer unit 33. The wind turbines 17 are electrically connected to the consumer unit 33 via the second inverter 18, the connection 19 and the local electrical network 13. This enables an AC to be provided directly to the consumer unit 33 from the wind turbines 17 without having to go via the battery 31. The wind turbines 17 provide a DC to the second inverter 18 and the second inverter 18 supplies an AC to the consumer unit 33.

The photovoltaic modules 23 are electrically connected to the consumer unit 33. The photovoltaic modules 23 are electrically connected to the consumer unit 33 via the first inverter 25. The photovoltaic modules 23 provide a DC to the first inverter 18, and in one mode of operation the first inverter 18 supplies an AC to the consumer unit 33.

For embodiments including the solar farm, the photovoltaic modules 27 are electrically connected to the consumer unit 33 via the third inverter 30, the connection 29, and the local electrical network 13. This enables an AC to be provided directly to the consumer unit 33 from the photovoltaic modules 27 without having to go via the battery 31. The photovoltaic modules 27 provide a DC to the third inverter 30, and the third inverter 30 supplies an AC to the consumer unit 33.

Electricity supplied to the dwelling 5 from the mains supply 9, the wind turbines 17 and/or the photovoltaic modules 27 is monitored by the dwelling electricity meter 15 and by the inverter generation meter 25a, the generation meters at the wind panels 17, 21 and/or the generation meters at the solar farm 27. Dwelling electrical apparatus is electrically connected to the consumer unit 33. Thus electricity can be supplied from the battery 31, the mains supply 9, wind turbines 17 and/or photovoltaic modules 27 to the dwelling electrical apparatus via the consumer unit 33. The dwelling electrical apparatus typically includes at least some of the following apparatus electrically connected to the consumer unit 33: at least one ring circuit 35 (sometimes referred to as ring mains) including several mains sockets; at least one lighting circuit 37 having several lighting units connected thereto, and preferably energy efficient lighting units such as LED lighting units; an electrical vehicle charger 39; a heating system 41; a continuous liquid flow heating device 43; appliances 45; security system/assisted living systems 46; and a water flow monitoring device 47.

The heating system 41 preferably includes a heat pump 49. The heating system 41 can include under floor heating pipes and/or wall mounted radiators 51. The heat pump 49 is arranged to heat water, which is supplied to under floor heating pipes and/or radiators 51. A heat pump 49 is an efficient way of heating the dwelling 5, and since it is powered by electricity, at least some of which is provided directly or indirectly by the wind turbines 17 and photovoltaic modules 23,27, helps to keep the carbon emissions from the dwelling 5 to a minimum. The heating system 41 includes smart heating controls 53, which enable operation of the heating system 41 to be controlled. The heating controls 53 can include smart thermostatic radiator valves and a smart thermostat. This enables the temperature in each room to be controlled independently of the other rooms.

The continuous liquid flow heating device 43 is connected to the dwelling's mains water supply 48 and is arranged to provide hot water on demand, for example via a tap 50. Providing the continuous liquid flow heating device 43 removes the need for a separate kettle and also removes the need for the heating system 41 to provide hot water to the taps 50 in addition to heating the dwelling 5. This is advantageous for the heating system 41 since the heat pump 49 operates more efficiently when it only has to perform a heating function, and is not also arranged to supply hot water to the taps 50. Thus there is an improved efficiency by the dwelling 5 having both the heat pump 49 and the continuous liquid flow heating device 43. The continuous liquid flow heating device 43 can be of the type supplied by Liquid Logical Limited, and as described in WO2008/110847 the contents of which are hereby incorporated by reference. This type of continuous liquid flow heating device 43 can heat water to temperatures in the range 30° C. to 100° C., provide it near instantaneously to a tap 50, reduce the amount of water wasted during the heating process, and is relatively low cost and easy to install. The system includes a water pipe having a heating element located within the pipe to heat the water. The heating element nearly fills the volume within the pipe. Thus the available volume for water within the pipe is relatively small, typically less than 20% of the available volume of the pipe, which ensures that the water within the pipe is exposed to as much of the surface area of the heating element as possible, for efficient heat transfer. Typically, the pipe is coiled.

The water flow monitoring device 47 monitors a flow rate of water within the dwelling's water system. The water flow monitoring device 47 is arranged to determine if there is a leak from the water system. For example, the water flow monitoring device 47 can detect if there is a water flow within a water pipe, at a time when the dwelling 5 is not occupied by the residents. The flow monitoring device 47 includes a transceiver for communicating over a wireless network. This enables data and commands to be communicated between the device 47 and a remote computer. The water flow monitoring device 47 can be arranged to locally and/or remotely shut off fluid flow through a water system when a leak condition is determined. The water flow monitoring device 47 can be self-powered. For example, the water flow monitoring device can be of the type described in WO2017060872 or US2018/0302697 the contents of which are hereby incorporated by reference.

The dwelling 5 has an energy management system 55. The energy management system 55 comprises a programmable logic controller (PLC). The main functions of the energy management system 55 are: to select at least one source of electricity 9,17,27,31,64 to supply electricity to the consumer unit 33; to select at least one source of electricity 9,17,23,27,64 to charge the battery 31; and to control exporting electricity from battery 31 to the national grid. These functions are performed according to a program stored in the PLC.

The energy management system 55 communicates with the dwelling electricity meter 15, the inverter generation meter 25a and/or the generation meters 21 at the wind farm and/or the generation meters 28 at the solar farm, the heat pump 49, smart heating controls 53, electric vehicle charger 39 and the electric vehicle battery 64 itself. This enables the energy management system 55 to monitor usage of electricity from the mains source 9, the wind turbines 17 and/or the photovoltaic modules 21,27. The energy management system 55 communicates with at least one of the first inverter 25, second inverter 18 and third inverter 30. This enables the energy management system 55 to control charging of the battery 31, to supply energy from the battery 31 to the consumer unit 33, and to export electricity from the battery 31 to the local network and/or the national grid. The energy management system 55 communicates with a home internet gateway 65. This enables the energy management system 55 to connect with a machine learning system 67, which can be a cloud machine learning system. Alternatively, the machine learning system 67 can be a module within the energy management system 55. The machine learning system 67 has access to: weather data 69; an artificial intelligence 71 that undertakes statistical learning and coordination with other home energy management systems; homeowner mobile app 73; and data from an energy services company 75. The energy management system 55 can receive data, control signals and program updates from the machine learning system 67.

The homeowner typically has an account 77 on a web-based portal and an app 73 on a mobile device such as a mobile phone or tablet. The app 73 enables the user to obtain data from the home energy management system 55, to adjust energy management system settings 55, and to control operation of any device in communication with the energy management system 55. The user is able to set user preferences 78, for example via the app 73.

The energy management system 55 can be programmed to communicate with at least one electrical device connected to the consumer unit 33. For example, the energy management system 55 can be programmed to control operation of the electric vehicle charger 39. The energy management system 55 can be programmed to control the charger 39 to charge the electric vehicle battery 64 in an efficient and/or environmentally friendly manner, for example by maximising the use of electricity from the photovoltaic modules 23,27 and wind turbine 17, and minimising electricity from the mains source 9, where possible. The electric vehicle charger 39 can be a two-way type electric vehicle charger (sometimes referred to as vehicle to home or vehicle to grid charger), which enables electricity to be supplied from the electric vehicle battery 64 to the consumer unit 33. The energy management system 55 can be arranged to control operation of the electric vehicle charger 39 to selectively supply electricity from the electric vehicle battery 64 to the consumer unit 33.

The energy management system 55 can be programmed to control operation of the heating system 41 to heat the dwelling 5 in an efficient, low cost and/or environmentally friendly manner, for example by maximising the use of electricity from the photovoltaic modules 23,27 and wind turbine 17, and minimising electricity from the mains source 9, where possible. The energy management system 55 can be programmed to control operation of at least some of: the ring circuits 35; the lighting circuits 37; the smart heating controls 53, including the thermostat and thermostatic radiator valves; the appliances 45; the security system/assisted living systems 46; and the water flow monitoring device 47.

If the energy management system 55 selects electricity from the mains source 9, the energy management system 55 can be arranged to use low cost tariffs where possible, for example using off peak tariffs.

The energy management system 55 can be programmed to control the supply of electrical energy to the dwelling 5 over a given period in the following manner.

At the start of the given period, the half-hourly electricity prices are set for the day ahead 79. This information is provided as an input to the energy management system 55.

The energy management system 55 checks 83 customer preferences, if any, which provide an indication of likely activities of the user for the period, such as out tomorrow, long drive, etc.

The energy management system 55 checks 85 the learnt use history for the customer, from a historical database.

The energy management system 55 checks 87 the weather for next 24 hrs from publicly available data, for example from location specific Meteorological Office data and/or a local on-site weather station. The weather the data can provide at least an indication of the wind speed, sunlight and temperature.

Optionally the energy management system 55 can check if there are any instructions from Distribution Network Operator (DNO), for example to disconnect from local public network 13 or dial down usage of electricity from the public network 9, or to provide similar ‘grid services’ for example including but not limited to frequency response.

The aforementioned data is achieved by the energy management system 55 communicating via an application programming interface (API) using the home internet gateway 65. Communication protocols such as ZigBee, or similar, can facilitate communications in the home if public internet unavailable. The energy management system 55 checks a database of if/then examples 88, and seeks to match received data with the examples stored in the database.

On the basis of the information obtained, the energy management system 55 calculates 89 the likely amount of energy required per hour or half hour for the given period of time, such as the next 24 hours, to charge the battery 31, and optionally the electric vehicle battery 64, and to provide sufficient electricity to the consumer unit 33. The energy management system 55 then determines an electricity supply strategy to meet the energy requirements. The energy management system 55 estimates the amount of energy that should be supplied by the photovoltaic modules 23,27, the wind turbines 17, and if necessary, the mains supply 9. The weather data obtained is useful in this determination since it provides the energy management system 55 information regarding wind speed and factors effecting solar power generation, and enables the energy management system 55 to estimate how much electrical energy each of the photovoltaic modules 23,27 and the wind turbines 17 are likely to generate during the relevant period.

The electrical energy supply strategy implemented by the energy management system 55 will in part depend on the time of day, since there will be no supply from the photovoltaic modules 23,27 during the night. For example, at night time the energy management system 55 can select from the following operational modes: charging 91 the dwelling battery 31 overnight using the wind turbines 17 and subsequently exporting 93 electricity from the battery 31 to local users; charging 95 the dwelling battery 31 overnight using the low cost mains supply 9, and subsequently exporting 93 electricity from the dwelling battery 31 to local users; no charging 99 required, dwelling battery 31 storage 101 is sufficient until next storage cycle; no charging 103 and exporting 97 energy stored in the dwelling battery 31 to local users; charging 104 the dwelling battery 31 overnight using mains supply 9 for use by the customer the next day, supplying electricity to the consumer unit 33 from the mains supply 9 and charging the electric vehicle battery 64 for use by the customer the next day; and charging 105 dwelling battery 31 overnight using wind turbines 17 for use by the customer the next day, supplying electricity to the consumer unit 33 from the wind turbines 17 and charging the electric vehicle battery 64.

Periodically, the energy management system 55 rechecks 107 the level of charge of the battery 31, and optionally the electric vehicle battery 64; recalculates 109 the amount of energy required per hour or half hour until the end of the period; and determines a strategy for meeting those energy requirements. Typically, there is at least one recheck 107 of the level of charge of the battery and the recalculation 109 of the amount of energy required per hour or half hour until the end of the period during a 24 hour period. In some arrangements, there is at least two rechecks and recalculations.

Typically, when recalculating 109 the energy requirements, the energy management system 55 obtains data regarding customer preferences 78, learnt use history for the customer from a historical database 85, the weather 111, and if there are any instructions from Distribution Network Operator (DNO) 113. The energy management system 55 estimates the amount of energy that should be supplied by the photovoltaic modules 23,27, the wind turbines 17, and if necessary, the mains supply 9.

During the day time, the energy management system 55 can select from the following operational modes: using 117 electricity from the wind turbines 17 to supply electricity to the consumer unit 33 and to charge the dwelling battery 31, with the object of storing sufficient energy in the battery 31 to meet electricity needs during a peak period; using 1119 electricity from the photovoltaic modules 23,27 to supply electricity to the consumer unit 33 and to charge the dwelling battery 31, with the object of storing sufficient energy in the battery 31 to meet electricity needs during a peak period; using 118 a combination of electricity from the wind turbines 17 and the photovoltaic modules 23,27 to supply electricity to the consumer unit 33 and to charge the dwelling battery 31, with the object of storing sufficient energy in the battery 31 to meet electricity needs during a peak period; charge 119 the dwelling battery 31 with electricity from the wind turbines 17 and use the mains source 9 to supply electricity to the consumer unit 33, with the object of fully charging the battery 31 to meet electricity needs during a peak period; charge 121 the dwelling battery 31 with electricity from the photovoltaic modules 23,27 and use the mains source 9 to supply electricity to the consumer unit 33, with the object of fully charging the battery 31 to meet electricity needs during a peak period; using a combination of wind turbines 17 and photovoltaic modules 23,27 to charge the battery 31, and using mains electricity 9 to supply the consumer unit 33, with the object of fully charging the battery 31 to meet electricity needs during a peak period; optionally exporting 122 surplus electricity stored in the battery 31 to the local area network 13 or grid 9; export 123 electricity generated by the photovoltaic modules 23,27 to the local area network 13 or grid 9, and supply electricity to the consumer unit 33 from the dwelling battery 31; export 125 electricity generated by the wind turbines 17 to the local area network 13 or grid 9, and supply electricity to the consumer unit 33 from the dwelling battery 31; and supply electricity to the consumer unit 33 from the mains supply 9, without charging the dwelling battery 31.

It will be appreciated that the energy management system 55 can be programmed to undertake other operational modes.

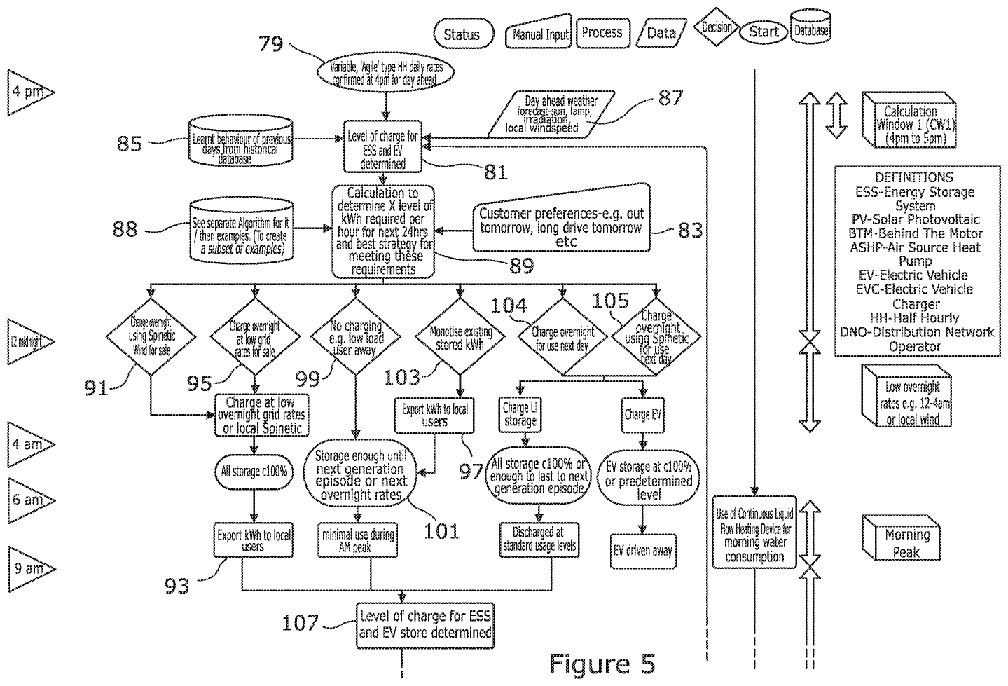

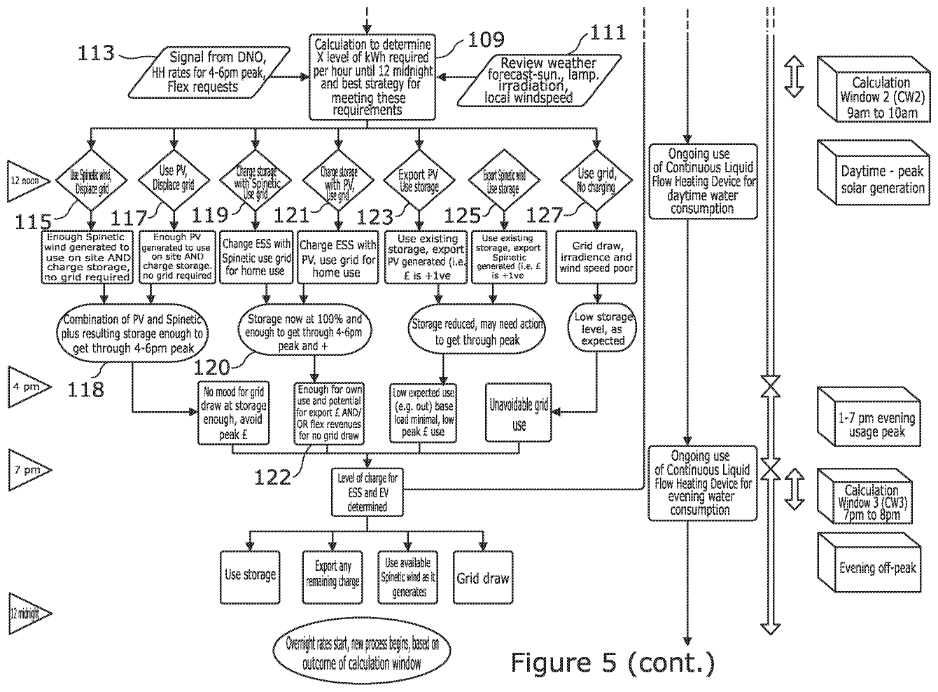

In the algorithm shown FIG. 5, a first calculation window takes place at 4 pm to 5 pm on day 1, a second calculation window takes place at 9 am to 10 am on day 2, and a third calculation window takes place at 7 pm to 8 pm on day 2. Of course, these times may be adjusted to suit the residential area 3. In some arrangements there are two calculation windows for a 24 hour period. In other arrangements there are three calculation windows for a 24 hour period. In other arrangements there are four calculation windows for a 24 hour period. Any suitable number of calculation windows can be used for a given period.

As a failsafe, if electrical supply from the photovoltaic modules 23,27 and the wind turbines 17 is interrupted, the energy management system 55 is arranged to automatically switch to the mains source 9 to ensure that there is a substantially uninterrupted supply of electricity to the consumer unit 33.

At the end of the given period, the energy management system 55 is programmed to start a new cycle.

Typically, the energy management system 55 charges the dwelling battery 31 using the following preferential order of electricity sources: photovoltaic modules 23,27, wind turbines 17, and main supply 9. The choice of electricity source 9,17,23,27 can be influenced by at least one of the following guidelines:
State of charge of storage in the dwelling battery 31: if low charge, top up; if high charge, use in home unless there are any instructions from DNO to disconnect from local network or dial down usage of electricity from public network, in which case save this ready for this specific time period, often evening peak time of 4-7 pm.
Weather impact on electricity generation: if sunny in next 24 hrs, use the photovoltaic modules 23,27 to supply electricity to the consumer unit 33, then charge the dwelling battery 31. If windy, use electricity from the wind turbines 17 to supply electricity to the consumer unit 33, then charge the dwelling battery 31 (note this may change over the course of the year).
Weather impact on consumption: if the air temperature is low in next 24 hrs, charge up the dwelling battery 31 to allow for use of the heating system 41 if the mains supply rates are higher than the anchor rate (previously agreed unit cost of electricity by which homeowner is charged per unit of electricity, e.g. x % less than OFGEM price cap, or x % less than Standard Variable Tariff from a given licensed energy supplier) and it is more economical to use electricity from the battery 31 to avoid higher mains supply rates.
Customer Preference: if the user has previously stated they will need their electric vehicle at a specific time, such as 7 am, then the energy management system 55 ensures the electric vehicle charger 39 charges the electric vehicle battery 64 fully by that time. Typically, the electric vehicle battery is not charged between 4-7 pm as this is peak time so usually higher costs or that the local network might not have the capacity.
Future electricity costs (if variable): discharge electricity from the dwelling battery 31 to the consumer unit 33 for use within the home, and do not take electricity from the mains supply 9 if rates are higher than the previously agreed anchor rate. The dwelling battery 31 is charged from the mains supply 9 if the mains electricity rate is less than anchor rate.

During the summer, when daylight is more common, the energy management system 55 is programmed to use electricity from the photovoltaic modules 23,27 to power the consumer unit 33 and to charge the dwelling battery 31 in preference to the wind turbines 17 and mains supply 9. Only if there is a predicted shortfall (either current or in imminent future time periods), does the energy management system 55 select electricity generated from the wind turbines 17 and/or mains supply 9.

During the winter, when daylight and hence photovoltaic generation is reduced, and the wind blows for longer overnight, the energy management system 55 is programmed to select electricity generated by the wind turbines 17 to charge the dwelling battery 31, to supply the consumer unit 33 and to charge the electric vehicle battery 64.

The energy management system 55 can be programmed to communicate with a thermostat in a heating system 41, and if the energy management system determines that the temperature of the water is low, the energy management system 55 activates the heat pump 49 using electricity received from the wind turbines 17, to heat up the hot water. The energy management system 55 can be programmed to activate the heat pump 49 for heating ahead of any peak time when drawing electricity from the mains supply 9 may cause local network problems and/or higher electricity costs. This latter running of the heat pump 49 for heating outside of a specifically mandated run period, is based on previously set minimum temperature requirements by the user in the user preferences.

This utilization of the wind turbines 17 during winter months corresponds with increased demand for heating from the heat pump 49, in contrast to the availability of electricity from the photovoltaic modules 23,27 during the summer, when heat pump 49 demand for heat is considerably lower.

By matching the wind turbine 17 output to user winter requirements substantially reduces or eliminates the need to draw electricity from the mains supply 9. Likewise, by matching photovoltaic 23,29 output to user summer requirements, substantially reduces or eliminates the need to draw electricity from the mains supply 9.

Table 1 below shows for a sample house how photovoltaics 23 combined with wind turbines 17, managed as a system, can match electrical demand with electricity generation, even when electric vehicle requirements are included. The model suggests total household demand, for a standard three-bed house in the United Kingdom, including 10 000 miles per annum from an electric vehicle, can be met, at least on a nominal basis, by combing solar and wind power.

TABLE 1

| | Demand (kWh) | Generation (kWh) |
|---|---|---|
| Power | 3227 | |
| SH & HW | 2613 | |
| Transport (10k miles p.a.) | 2278 | |
| Solar photovoltaics | | 4420 |
| Local Wind | | 2984¹ |
| Total | 8117 | |
| Total Optimised² | 7305 | 7404 |

¹Assumes three Spinetic wind turbine panels 17 per dwelling 5, generating 994 kWh per wind turbine panel 17, at 4.5 m/s.
²Assume 10% reduction in Demand due to energy management system 55 energy savings, evidence suggests higher reductions in demand may be possible.

In the arrangement described above, the battery storage 31 acts as a buffer and there is likely to be a need for small amount of electric drawn from the mains supply 9, however this would be matched by similar levels of electricity export. The home energy management software 55 will coordinate this.

The electrical system 1 can be applied to new build residential sites 3. The electrical system 1 can be retrofitted to existing residential sites 3.

The description presents exemplary embodiments and, together with the drawings, serves to explain principles of the invention. The scope of the invention, however, is not intended to be limited to the precise details of the embodiments.

Furthermore, it will be appreciated by the skilled person that modifications can be made to the above embodiments that fall within the scope of the invention, for example energy stores other than batteries can be used. However, the energy store must be capable of providing electricity, or converting stored energy into electricity.

An energy store can be included in the electrical system 1 that serves a plurality of dwellings. For example, a communal battery 80 can be provided that is electrically connected to a plurality of consumer units 33. The communal battery 80 can be selectively charged by the photovoltaics 23,27, wind turbines 17 and mains electricity 9 sources. A communal energy management system can be provided for selectively charging the communal battery 80 from the photovoltaics 23,27, wind turbines 17 and mains electricity 9 sources. The communal energy management system can be arranged to preferentially store energy in the energy store 80 from the wind power system 17 and the solar power system 23,27, using the mains 9 source to top up energy where necessary. Each dwelling 5 has a consumer unit 33. Each consumer unit 33 can be electrically connected to the communal battery 80 via at least one inverter. The communal energy management system can be arranged to selectively supply electricity to the consumer units 33 from the communal battery 80. The communal energy management system can be arranged to export electricity from the communal battery 80 to at least one of the local area network 13 and the national grid 9.

The communal battery 80 can be a lithium based battery, that is, a battery that includes lithium. The communal battery can have a large capacity, for example the communal battery can be a megawatt sized battery.

The site 3 can include a plurality of communal batteries 80, which each communal battery 80 being electrically connected a set of consumer units 33 (and hence a set of dwellings 55). Each communal battery 80 can have a respective communal energy management system, which is arranged to selectively supply each consumer unit 33 in the set of consumer units with electricity.

The electrical system 1 can include a site backup energy store, such as a backup battery 90. The battery 90 can be a lithium based battery, that is, a battery that includes lithium. The backup battery is connected to the mains source 9 and to the local electrical network 13. The backup battery 90 provides grid services. For example, in the event of a loss of mains source 9 to the local electrical network 13, the backup battery 90 supplies electricity to the local electrical network 13, and hence the dwelling consumer units 33. This can be for planned and/or unplanned outages. A planned outage may be for maintenance work. For example, the DNO may want to undertake maintenance work on the site which requires the mains source 9 to be disconnected. The backup battery 90 can provide the site 3 with electricity during the maintenance period, for example if there is insufficient supply capacity from the communal batteries 80 alone. The backup battery 90 can be used for balancing of the electrical network, for example the battery backup 90 can assist with frequency balancing. The backup battery 90 is typically charged from the mains source 9. Charging of the backup battery 90 can take place when electricity cost is low. In some circumstances, the backup battery 90 can export electricity to earn revenue.

For some dwellings 5, the heating system 41 can include a thermal energy store, such as a hot water tank, a smart hot water tank and/or a thermal energy store using a PCM. For example, instead of having a continuous liquid flow heating device 43, the heating system 41 can store hot water in the hot water tank or a smart hot water tank. The hot water can be supplied to the taps 50.

The electrical system 1 can be used with different types of dwellings, for example typical single storey homes, two storey homes and three storey homes, blocks of flats, elevatable houses such as those described in WO2016166519, and houses located on carparks. The dwellings can be detached houses, semi-detached houses or terraced houses. The electrical system can be used for any suitable type of dwelling.

The heating system 41 can comprise at least one infra-red heating device to heat the dwelling in addition, or as an alternative, to the heat pump 49.

1. An electrical system for a residential site having at least one dwelling, the electrical system including: a consumer unit; an electric vehicle charger, wherein electric vehicle charger is electrically connected to the consumer unit and is powered by electricity received from the consumer unit; an energy store; a wind power system for converting wind energy into electrical energy, the wind power system is electrically connected to the energy store; a solar power system for converting solar energy into electrical energy, the solar power system is electrically connected to the energy store; a connection electrically connecting the energy store to a mains electrical source; and an energy management system, wherein the energy management system is arranged to: selectively store energy from at least one of the wind power system, the solar power system and the mains electrical source in the energy store during an energy storage procedure; obtain weather data; estimate the amount of electricity the wind power system will generate over a relevant period, the estimate at least in part being based on the weather data; estimate the amount of electricity the solar power system will generate over the relevant period, the estimate at least in part being based on the weather data; estimate the amount of electrical energy the dwelling will require for the relevant period of time; determine a strategy for meeting the estimated energy requirements for the dwelling based at least in part on the estimated availability of electricity from the wind power system and the solar power system, and using electricity from the energy store, mains source and/or electric vehicle battery to make up any shortfall in energy supplied by the wind power system and the solar power system; selectively supply the consumer unit with electricity from the energy store; control operation of the electric vehicle charger to selectively supply electricity from an electric vehicle battery to the consumer unit; and selectively export electricity from the energy store to a local electricity network for distribution to other dwellings located on the residential site and/or to the mains source for distribution on the national grid.

2. The electrical system of claim 1, including at least one inverter device, wherein at least one of the wind power system and the solar power system is electrically connected to the battery via the at least one inverter device.

3. The electrical system of claim 2, wherein the inverter device comprises a hybrid inverter device.

4. The electrical system of claim 1, wherein the wind power system, is electrically connected to the consumer unit, and the energy management system is arranged to selectively provide electricity to the consumer unit from the wind power system.

5. The electrical system of claim 1, wherein the solar power system is electrically connected to the consumer unit, and the energy management system is arranged to selectively provide electricity to the consumer unit from the solar power system.

6. The electrical system of claim 1, including a connection electrically connecting the mains electrical source to the consumer unit, and the energy management system is arranged to selectively provide electricity to the consumer unit from the mains source.

7. The electrical system of claim 1, wherein the energy store comprises at least one rechargeable electrochemical cell.

8. The electrical system according to claim 7, wherein the at least one rechargeable electrochemical cell comprises a battery including lithium.

9. The electrical system of claim 1, wherein the wind power system includes at least one wind turbine.

10. The electrical system of claim 9, the at least one wind turbine includes a frame having first and second longitudinal members arranged parallel to one another, at least one turbine blade located between the first and second longitudinal members, the at least one turbine blade being rotatably supported at a first end by the first longitudinal member and rotatably supported at a second end by the second longitudinal member, wherein the at least one turbine blade is arranged to rotate about an axis that is arranged perpendicularly to each of the first and second longitudinal members.

11. The electrical system of claim 10, wherein the at least one turbine blade has an electrical generator, a first part of the electrical generator is attached to the at least one turbine blade and a second part of the electrical generator is mounted on one of the first and second longitudinal members, wherein rotational movement of the first part of the generator with respect to the second part of the generator generates an electrical current.

12. The electrical system of claim 1, wherein the solar power system includes at least one, and preferably a plurality of photovoltaic modules.

13. The electrical system of claim 1, wherein the energy management system is arranged to determine the amount of energy stored in the energy store.

14. The electrical system of claim 13, wherein the energy management system is arranged to initiate an energy storage procedure when the determined amount of energy stored in the energy store is less than a threshold value.

15. The electrical system of claim 1, wherein the energy management system is arranged to obtain historical data relating to electrical usage for the dwelling.

16. The electrical system of claim 1, wherein the energy management system is arranged to obtain data relating to user preferences.

17. The electrical system of claim 1, wherein the energy management system is arranged to store in the energy store energy received from one of the wind power system, the solar power system and the mains source, and to simultaneously power the consumer unit with electricity received from another one of the wind power system, the solar power system and the mains source.

18. The electrical system of claim 1, wherein the energy management system is arranged to selectively store energy obtained from the wind power system and/or the solar power system in an electric vehicle battery, making up any shortfall of energy from the mains electrical source.

19. The electrical system of claim 1, including a heating system arranged to heat the dwelling, said heating system having at least one of a heat pump and an infra-red heater device, wherein the heating system is electrically connected to the consumer unit and is powered by electricity received from the consumer unit.

20. The electrical system of claim 1, including a continuous liquid flow heating device arranged to provide hot water to the dwelling, wherein the continuous liquid flow heating device is electrically connected to the consumer unit and is powered by electricity received from the consumer unit.

21. The electrical system of claim 1, including at least one of the following electrically connected to the consumer unit, and arranged to be powered by electricity received from the consumer unit: at least one ring circuit including several mains sockets; at least one lighting circuit; appliances; a security system; assisted living systems; and a water flow monitoring device.

22. The electrical system of claim 1, wherein the energy store is dedicated to a single dwelling.

23. The electrical system of a m claim 1, wherein the residential site includes a plurality of dwellings, each dwelling having a respective consumer unit, and the energy store comprises a communal energy store that is electrically connected to each consumer unit.

24. The electrical system of claim 23, wherein the energy management system comprises a communal energy management system arranged to selectively provide electricity from the communal energy store to each consumer unit electrically connected to the communal energy store.

25. The electrical system of claim 1, including a backup energy store.

26. The electrical system of claim 1, including a circuit breaker to selectively supply electricity from the electric vehicle battery to the consumer unit.

27. The electrical system according to claim 26, wherein the circuit breaker is controlled by a micro-controller, and the energy management system is arranged to control operation of the micro-control to selectively supply electricity from the electric vehicle battery to the consumer unit in response to local network conditions.

28.-43. (canceled)
